(19) United States
(12) Patent Application Publication
(10) Pub. No.: US 2012/0219841 A1
(43) Pub. Date: Aug. 30, 2012

(54) LITHIUM ION CELL DESIGN APPARATUS AND METHOD

(75) Inventors: Hooman Bolandi, San Jose, CA (US); Mahendra C. Orilall, Santa Clara, CA (US); Victor Pebenito, San Jose, CA (US); Karl M. Brown, Santa Clara, CA (US); Michael C. Kutney, Santa Clara, CA (US); Connie P. Wang, Mountain View, CA (US); Robert Z. Bachrach, Burlingame, CA (US)

(73) Assignee: APPLIED MATERIALS, INC., Santa Clara, CA (US)

(21) Appl. No.: 13/402,724

(22) Filed: Feb. 22, 2012

Related U.S. Application Data
(60) Provisional application No. 61/446,836, filed on Feb. 25, 2011.
(60) Provisional application No. 61/538,005, filed on Sep. 22, 2011.
(60) Provisional application No. 61/551,514, filed on Oct. 26, 2011.

(51) Int. Cl. H01M 2/16; B05D 5/12; C23C 4/12; B05C 13/02; B05B 17/00; H01M 2/18; B05D 1/04; B82Y 30/00

(52) U.S. Cl. 429/144; 427/58; 427/458; 427/446; 118/58; 977/762

(57) ABSTRACT

A spray module for depositing an electro-active material over a flexible conductive substrate is provided. The spray module comprises a first heated roller for heating and transferring the flexible conductive substrate, a second heated roller for heating and transferring the flexible conductive substrate, a first spray dispenser positioned adjacent to the first heated roller for depositing electro-active material onto the flexible conductive substrate as the flexible conductive substrate is heated by the first heated roller, and a second spray dispenser positioned adjacent to the second heated roller for depositing electro-active material over the flexible conductive substrate as the flexible conductive substrate is heated by the second heated roller.

### CROSS-REFERENCE TO RELATED APPLICATIONS

This application claims benefit of U.S. Provisional Patent Application Ser. No. 61/446,836, filed Feb. 25, 2011 (Attorney Docket Number 016210L), U.S. Provisional Patent Application Ser. No. 61/538,005, filed Sep. 22, 2011 (Attorney Docket Number 015717L), and U.S. Provisional Patent Application Ser. No. 61/551,514, filed Oct. 26, 2011 (Attorney Docket Number 016108L), all of which are herein incorporated by reference in their entirety.

### GOVERNMENT RIGHTS IN THIS INVENTION

This invention was made with Government support under DE-AR0000063 awarded by DOE. The Government has certain rights in this invention.

### BACKGROUND OF THE INVENTION

1. Field of the Invention

Embodiments of the present invention relate generally to high-capacity energy storage devices, and more specifically, to device components, systems and apparatus for fabricating energy storage devices and device components.

2. Description of the Related Art

High-capacity energy storage devices, such as lithium-ion (Li-ion) batteries, are used in a growing number of applications, including portable electronics, medical, transportation, grid-connected large energy storage, renewable energy storage, and uninterruptible power supply (UPS).

Li-ion batteries typically include an anode electrode, a cathode electrode and a separator positioned between the anode electrode and the cathode electrode. The separator is an electronic insulator which provides physical and electrical separation between the cathode and the anode electrodes. The separator is typically made from micro-porous polyethylene and polyolefin, and is applied in a separate manufacturing step.

During electrochemical reactions, i.e., charging and discharging, Li-ions are transported through the pores in the separator between the two electrodes via an electrolyte. Thus, high porosity is desirable to increase ionic conductivity. However, some high porosity separators are susceptible to electrical shorts when lithium dendrites formed during cycling create shorts between the electrodes.

The separator is also one of the most expensive components in the Li-ion battery and accounts for over 20% of the material cost in battery cells. Currently, battery cell manufacturers purchase separators, which are then laminated together with anode and cathode electrodes in separate processing steps. Separators may be made by wet or dry extrusion of a polymer and then stretched to produce holes (tears) in the polymer. Production of other separators may involve dissolution of the polymer material in organic solvents. However, many of the organic solvents used negatively affect the environment and present disposal problems.

For most energy storage applications, the charge time and capacity of energy storage devices are important parameters. In addition, the size, weight, and/or expense of such energy storage devices can be significant limitations. The use of current separators has a number of drawbacks. Namely, such materials limit the minimum size of the electrodes constructed from such materials, suffer from electrical shorts, require complex manufacturing methods, and expensive materials.

One method for manufacturing anode electrodes and cathode of electrodes for energy storage devices is principally based on slit coating of viscous powder slurry mixtures of cathodically or anodically active material onto a conductive current collector followed by prolonged heating to form a dried cast sheet and prevent cracking. The thickness of the electrode after drying which evaporates the solvents is finally determined by compression or calendering which adjusts the density and porosity of the final layer. Slit coating of viscous slurries is a highly developed manufacturing technology which is very dependent on the formulation, formation, and homogenation of the slurry. The formed active layer is extremely sensitive to the rate and thermal details of the drying process.

Among other problems and limitations of this technology is the slow and costly drying component which requires both a large footprint (e.g., up to 50 meters long) and an elaborate collection and recycling system for the evaporated volatile components. Many of these are volatile organic compounds which additionally require an elaborate abatement system. Further, the resulting electrical conductivity of these types of electrodes also limits the thickness of the electrode and thus the volume of the electrode.

Accordingly, there is a need in the art for systems and apparatus for more cost effectively manufacturing faster charging, higher capacity energy storage devices that are smaller, lighter, and can be manufactured at a high production rate without detrimentally effecting the environment.

### SUMMARY OF THE INVENTION

Embodiments of the present invention relate generally to high-capacity energy storage devices, and more specifically, to device components, systems and apparatus for fabricating energy storage devices and device components. In one embodiment a method for depositing an electro-active material over a flexible conductive substrate is provided. The method comprises transferring a flexible conductive substrate over a first heated roller while simultaneously spraying a first electro-active material over the flexible conductive substrate and transferring the flexible conductive substrate over a second heated roller while simultaneously spraying a second electro-active material over the flexible conductive substrate.

In another embodiment a spray module for depositing an electro-active material over a flexible conductive substrate is provided. The spray module comprises a first heated roller for heating and transferring the flexible conductive substrate, a second heated roller for heating and transferring the flexible conductive substrate, a first spray dispenser positioned adjacent to the first heated roller for spraying electro-active material onto the flexible conductive substrate as the flexible conductive substrate is heated by the first heated roller, and a second spray dispenser positioned adjacent to the second heated roller for spraying electro-active material over the flexible conductive substrate as the flexible conductive substrate is heated by the second heated roller.

In yet another embodiment a separator for separating an anode electrode and a cathode electrode is provided. The separator comprises a polyvinyl alcohol (PVA) layer and inorganic particles embedded in the PVA layer. The separator may be porous.

In yet another embodiment, a lithium-ion battery having an electrode structure is provided. The electrode structure comprises an anode stack, a cathode stack, and a PVA separator. The anode stack comprises an anodic current collector and an anode structure formed over a first surface of the anodic current collector. The cathode stack comprises a cathodic current collector and a cathode structure formed over a first surface of the cathodic current collector. The PVA separator is positioned between the anode structure and the cathode structure.

In yet another embodiment, a method of forming an electrode structure is provided. The method comprises applying a voltage to a polymer containing liquid mixture comprising polyvinyl alcohol and water and electrospinning a nano-fiber backbone structure from the polymer containing liquid mixture directly onto a surface of an electrode structure to form a porous electrospun polymer separator.

In yet another embodiment, a method of forming an electrode structure is provided. The method comprises providing a first electrode structure and forming a polyvinyl alcohol (PVA) separator on the first electrode structure. The PVA separator comprises PVA and an inorganic component.

### BRIEF DESCRIPTION OF THE DRAWINGS

So that the manner in which the above-recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1A is a schematic diagram of a partial Li-ion battery cell bi-layer with a polyvinyl alcohol (PVA) separator according to embodiments described herein;

FIG. 1B is a schematic diagram of a partial Li-ion battery cell with a PVA separator according to embodiments described herein;

FIG. 2 is a schematic diagram of a cross-sectional view of one embodiment of a cathode stack and an anode stack with a PVA separator formed according to embodiments described herein;

FIG. 3 is a process flow chart summarizing one embodiment of a method for forming the cathode stack and the anode stack of FIG. 2 according to embodiments described herein;

FIG. 4 is a plot depicting the cycling data for a coin cell using one embodiment of the PVA separator formed according to embodiments described herein verses a commercially available separator;

FIG. 5 is a plot depicting the cycling data for a coin cell using one embodiment of the PVA separator formed according to embodiments described herein;

FIG. 6 is a plot depicting pore size distribution versus average diameter for one embodiment of the PVA separator formed according to embodiments described herein verses a commercially available separator;

FIG. 7 is a schematic illustration of one embodiment of a vertical in-line spray processing system according to embodiments described herein;

FIG. 8 is a schematic cross-sectional view of one embodiment of a spray module having heated rollers according to embodiments described herein;

FIG. 9 is a schematic top view of one embodiment of the spray module of FIG. 8 according to embodiments described herein;

FIG. 10A is a perspective view of one embodiment of a spray dispenser assembly according to embodiments described herein;

FIG. 10B is a top view of one embodiment of the spray dispenser assembly depicted in FIG. 10A; and

FIG. 11 is a schematic view of another embodiment of a spray module according to embodiments described herein.

To facilitate understanding, identical reference numerals have been used, where possible, to designate identical elements that are common to the figures. It is contemplated that elements disclosed in one embodiment may be beneficially utilized on other embodiments without specific recitation.

### DETAILED DESCRIPTION

Embodiments of the present invention relate generally to high-capacity energy storage devices, and more specifically, to batteries having integrated separators and methods of fabricating such batteries. Other applications for which the embodiments described herein may be used include but are not limited to fuel cells, membranes, photovoltaics, supercapacitors, sensors, and other applications such as filtration and catalysis where porous films are necessary.

Embodiments of the present invention further relate generally to high-capacity energy storage devices, and more specifically, to a system and an apparatus for fabricating energy storage devices and device components using heated rollers and spray deposition techniques. It has been found that spraying of electro-active materials onto a conductive substrate while the substrate passes over a heated roller leads to the deposition of a dry or mostly dry film. Deposition of a dry or mostly dry film eliminates the need for large and costly drying mechanism thus reducing both the cost and footprint of the apparatus.

As used herein, “spray deposition techniques” include, but are not limited to, hydraulic spray techniques, atomizing spray techniques, electrospray techniques, plasma spray techniques, and thermal or flame spray techniques.

As used herein, the term “vertical” is defined as a major surface or deposition surface of the flexible conductive substrate being perpendicular relative to the horizon.

As used herein, the term “horizontal” is defined as a major surface or deposition surface of the flexible conductive substrate being parallel relative to the horizon.

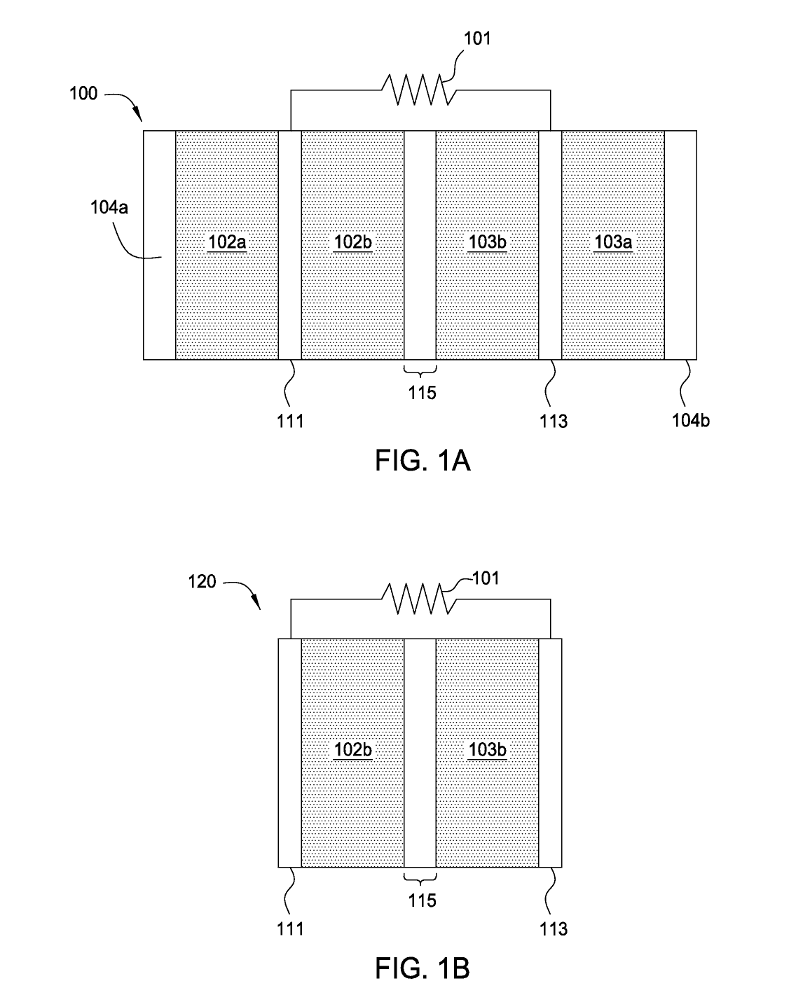

Certain embodiments described herein include the manufacturing of battery cell electrodes by incorporating electro-active materials into three-dimensional conductive porous structures using spray deposition techniques to form anodically active or cathodically active layers on substrates which function as current collectors, for example, copper substrates for anodes and aluminum substrates for cathodes. For bi-layer battery cells and battery cell components, opposing sides of the processed substrate may be simultaneously processed to form a bi-layer structure. Exemplary embodiments of anode structures and cathode structures which may be formed using the embodiments described herein are described in FIGS. 1, 2A-2D, 3, 5A and 5B and corresponding paragraphs [0041]-[0066] and [0094]-[0100] of commonly assigned U.S. patent application Ser. No. 12/839,051, (Attorney Docket No. APPM/014080/EES/AEP/ESONG), filed Jul. 19, 2010, to Bachrach et al., titled COMPRESSED POWDER 3D BATTERY ELECTRODE MANUFACTURING, now published as US 2011/0129732, of which the aforementioned figures and paragraphs are herein incorporated by reference.

As deposited, the electro-active materials may comprise nano-scale sized particles and/or micro-scale sized particles. The electro-active materials may be deposited over three-dimensional conductive porous structures. The three-dimensional conductive porous structure may be formed by at least one of: a porous electroplating process, an embossing process, or a nano-imprinting process. In certain embodiments, the three-dimensional conductive porous structure comprises a wire mesh structure. The formation of the three-dimensional conductive porous structure determines the thickness of the electrode and provides pockets or wells into which the electro-active powders may be deposited using the systems and apparatus described herein.

The use of various types of substrates on which the materials described herein are formed is also contemplated. While the particular substrate on which certain embodiments described herein may be practiced is not limited, it is particularly beneficial to practice the embodiments on flexible conductive substrates, including for example, web-based substrates, panels and discrete sheets. The substrate may also be in the form of a foil, a film, or a thin plate. In certain embodiments where the substrate is a vertically oriented substrate, the vertically oriented substrate may be angled relative to a vertical plane. For example, the substrate may be slanted from between about 1 degree to about 20 degrees from the vertical plane. In certain embodiments where the substrate is a horizontally oriented substrate, the horizontally oriented substrate may be angled relative to a horizontal plane. For example, the substrate may be slanted from between about 1 degree to about 20 degrees from the horizontal plane. In certain embodiments, it may be beneficial to practice the embodiments on non-conductive flexible substrates. Exemplary non-conductive substrates include polymeric substrates.

Integrated Green Separator for Li-Ion Batteries

Embodiments of the present invention generally relate to an integrated separator comprising water-soluble polyvinyl alcohol (PVA). Apart from being environmentally friendly, PVA is also relatively inexpensive. The melting point of PVA varies between 180-230 degrees Celsius depending on the degree of hydrolyzation. PVA also has tensile strength and flexibility. To obtain porous films of PVA, hot-spraying or electrospinning techniques can be employed. Hot-spraying techniques, electrospinning techniques, doctor (dr) blading techniques, or combinations thereof may be used to form the PVA separator. These processes allow for control over thickness and porosity and can be carried out in large format equipment and ultimately, will reduce the overall cost of batteries. In certain embodiments, fabrication of the PVA separator is performed in an assembly line that also includes fabrication of the electrodes.

In certain embodiments, inorganic components may be incorporated into the PVA material for mechanical strength. The inorganic components may be ceramic particles. The inorganic components may be incorporated into the integrated separator as additional layer(s), e.g., AB or BAB where A is the PVA layer and B is a ceramic layer. Alternatively, ceramic particles or precursors may be added to the polymer solution or separator forming solution which can then be hotsprayed or electrospun to obtain an organic-inorganic hybrid multifunctional film. The latter design would provide thinner films, which are desirable for power applications, and fewer processing steps would result in reduced costs.

In certain embodiments, additional polymers may be incorporated into the integrated separator for thermal stability. Exemplary additional polymers and their respective melting points include: polymethylmethacrylate (PMMA) (m.p. ˜130° C.); Nylon-6 (m.p. ˜22° C.); and polyacrylonitrile (PAN) (m.p. ˜317° C.). These additional polymers may be included as additional layer(s), e.g., AB or BAB. The advantage of multiple layers is that one layer can act as a shutdown mechanism to prevent thermal runaway. Alternatively, a single multifunctional layer can be obtained by simultaneously fabrication of two such polymers using multiple nozzles, for either hotspraying or electrospinning.

The PVA separator may be formed using deposition techniques including but not limited to electrospraying techniques, electrospinning techniques, and doctor (dr) blading techniques.

The PVA separator may be formed from a polymer solution or a separator forming solution. The polymer solution or separator forming solution comprises PVA, and optionally an inorganic component or precursors for forming the inorganic component diluted in a solvent system. PVA may comprise from about 0.5 wt. % and about 95 wt. % of the total weight of the polymer solution or separator forming solution. For electrospraying techniques and electrospraying techniques, PVA may comprise from about 0.5 wt. % to about 30 wt. % of the polymer solution or separator forming solution. For electrospraying techniques and electrospraying techniques, PVA may comprise from about 10 wt. % to about 20 wt. % of the polymer solution or separator forming solution. For dr blading techniques, PVA may comprise from about 50 wt. % to about 95 wt. % of the polymer solution or the separator forming solution. For dr blading techniques, PVA may comprise from about 60 wt. % to about 80 wt. % of the polymer solution or the separator forming solution.

The solvent system is water. The solvent system may comprise the remainder of the polymer solution or the separator forming solution. The solvent system may comprise from about 50 wt. % to about 99.5 wt. % of the total weight of the polymer solution or the separator forming solution. The solvent system may comprise from about 60 wt. % to about 80 wt. % of the total weight of the polymer solution or the separator forming solution.

The polymer solution or separator forming solution may further comprise inorganic components. The inorganic components may comprise from about 1 wt. % to about 5 wt. % of the polymer solution or the separator forming solution. The inorganic components may be selected from a variety of materials that are compatible with the battery materials and chemistry into which the integrated separator is incorporated. The inorganic material may be a ceramic material. Exemplary ceramic materials include BaTiO₃, HfO₂ (hafnia), SrTiO₃, TiO₂ (titania), SiO₂ (silica), Al₂O₃ (alumina), ZrO₂ (zirconia), SnO₂, CeO₂, MgO, CaO, Y₂O₃, CaCO₃, and combinations thereof. In one embodiment, the ceramic particles are selected from the group comprising SiO₂, Al₂O₃, MgO, and combinations thereof.

The size of the ceramic particles may be selected such that the particle size is less than the diameter of the polymer fibers and the particles will not clog the deposition system. In certain embodiments, the ceramic particles may have a particle size between about 5 nm to about 0.5 μm. The particles may be less than 300 nm in diameter, or less than 100 nm in diameter, and more typically from about 10-20 nm in diameter. The small particle size of the ceramic particles makes it more difficult for lithium dendrites formed during the cycling process from growing through the separator and causing shorts.

Ceramic particles may be added to the polymer solution or separator forming solution using a sol-gel process. In a sol-gel process, inorganic precursors are added to the polymer solution and react to form ceramic particles in the polymer solution. For example, inorganic precursors such as TiCl₄ and Ti(OH)₄ are added to the polymer solution and react to form TiO₂ sol particles. Thus, the precursors for the ceramic particles are added to the polymer solution. The ceramic particles may form as the precursors are mixed or in some cases, the precursors may require heating the mixture or heating the fibers after they have been electrospun. The heating temperature will be less than the melting temperature of the polymer fibers.

The polymer fibers may be formed from a polymer melt. Polymers which are molten at high temperatures may be used in the melt process. Electrospinning of the polymer melt is similar to the process for electrospinning of the polymer solution, however, electrospinning of the polymer melt is performed in a vacuum environment. The charged melt jet, substrate that the melt is deposited on are typically encapsulated in a vacuum environment.

For electrospinning processes, parameters which may affect the formation of fibers include solution properties (e.g., conductivity, surface tension, viscosity, and elasticity), the distance between the capillary tube, electric potential at the capillary tip, and ambient parameters (e.g., humidity, solution temperature, and air velocity).

FIG. 1A is a schematic diagram of a partial Li-ion battery cell bi-layer 100 with a PVA separator 115 formed according to embodiments described herein. FIG. 1B is a schematic diagram of a partial Li-ion battery cell 120 with a PVA separator formed according to embodiments described herein. The Li-ion battery cells 100, 120 are electrically connected to a load 101, according to one embodiment described herein. The primary functional components of the Li-ion battery cell bi-layer 100 include anode structures 102a, 102b, cathode structures 103a, 103b, separator layers 104a, 104b, the PVA separator 115, current collectors 111 and 113 and an electrolyte (not shown) disposed within the region between the separator layers 104a, 104b. The primary functional components of the Li-ion battery cell 120 include anode structure 102b, cathode structure 103b, the electrospun PVA separator 115, current collectors 111 and 113 and an electrolyte (not shown) disposed within the region between the current collectors 111, 113. A variety of materials may be used as the electrolyte, for example, a lithium salt in an organic solvent. The Li-ion battery cells 100, 120 may be hermetically sealed with electrolyte in a suitable package with leads for the current collectors 111 and 113. The anode structures 102a, 102b, cathode structures 103a, 103b, the PVA separator 115, and fluid-permeable separator layers 104a, 104b are immersed in the electrolyte in the region formed between the separator layers 104a and 104b. It should be understood that a partial exemplary structure is shown and that in certain embodiments the separator layers 104a and 104b are replaced with separator layers similar to the PVA separator 115 followed by corresponding anode structures, cathode structures, and current collectors.

Anode structure 102b and cathode structure 103b serve as a half-cell of Li-ion battery 100. Anode structure 102b includes a metal anodic current collector 111 and a first electrolyte containing material, such as a carbon-based intercalation host material for retaining lithium ions. Similarly, cathode structure 103b includes a cathodic current collector 113 respectively and a second electrolyte containing material, such as a metal oxide, for retaining lithium ions. The current collectors 111 and 113 are made of electrically conductive material such as metals. In one embodiment, the anodic current collector 111 comprises copper and the cathodic current collector 113 comprises aluminum. The electrospun PVA separator 115 is used to prevent direct electrical contact between the components in the anode structure 102b and the cathode structure 103b.

The electrolyte containing material on the cathode side of the Li-ion battery cell 100, 120 or positive electrode, may comprise a lithium-containing metal oxide, such as lithium cobalt dioxide (LiCoO₂) or lithium manganese dioxide (LiMnO₂). The electrolyte containing material may be made from a layered oxide, such as lithium cobalt oxide, an olivine, such as lithium iron phosphate, or a spinel, such as lithium manganese oxide. In non-lithium embodiments, an exemplary cathode may be made from TiS₂ (titanium disulfide). Exemplary lithium-containing oxides may be layered, such as lithium cobalt oxide (LiCoO₂), or mixed metal oxides, such as LiNiₓCo₁₋₂ₓMnO₂, LiNi_{0.5}Mn_{1. 5}O₄, Li(Ni_{0.8}Co_{0.15}Al_{0.05})O₂, LiMn₂O₄. Exemplary phosphates may be iron olivine (LiFePO₄) and it is variants (such as LiFe₁₋ₓMgPO₄), LiMoPO₄, LiCoPO₄, LiNiPO₄, Li₃V₂(PO₄)₃, LiVOPO₄, LiMP₂O₇, or LiFe_{1.5}P₂O₇. Exemplary fluorophosphates may be LiVPO₄F, LiAIPO₄F, Li₅V(PO₄)₂F₂, Li₅Cr(PO₄)₂F₂, Li₂CoPO₄F, or Li₂NiPO₄F. Exemplary silicates may be Li₂FeSiO₄, Li₂MnSiO₄, or Li₂VOSiO₄. An exemplary non-lithium compound is Na₅V₂(PO₄)₂F₃.

The electrolyte containing material on the anode side of the Li-ion battery cell 100, 120 or negative electrode, may be made from materials described above, for example, graphitic particles dispersed in a polymer matrix and/or various fine powders, for example, micro-scale or nano-scale sized powders. Additionally, microbeads of silicon, tin, or lithium titanate (Li₄Ti₅O₁₂) may be used with, or instead of, graphitic microbeads to provide the conductive core anode material. Exemplary cathode materials, anode materials, and methods of application are further described in commonly assigned U.S. patent application Ser. No. 12/839,051, (Attorney Docket No. APPM/014080/EES/AEP/ESONG), filed Jul. 19, 2010 titled COMPRESSED POWDER 3D BATTERY ELECTRODE MANUFACTURING, now published as US 2011/0129732, and commonly assigned U.S. patent application Ser. No. 12/953,134, (Attorney Docket No. APPM/014493/LES/AEP/ESONG), filed Jan. 13, 2010, titled GRADED ELECTRODE TECHNOLOGIES FOR HIGH ENERGY LITHIUM-ION BATTERIES, now published as US 2011/0168550, both of which are herein incorporated by reference in their entirety. It should also be understood that although a Li-ion battery cell bi-layer 100 is depicted in FIGS. 1A and 1B, the embodiments described herein are not limited to Li-ion battery cell bi-layer structures. It should also be understood, that the anode and cathode structures may be connected either in series or in parallel.

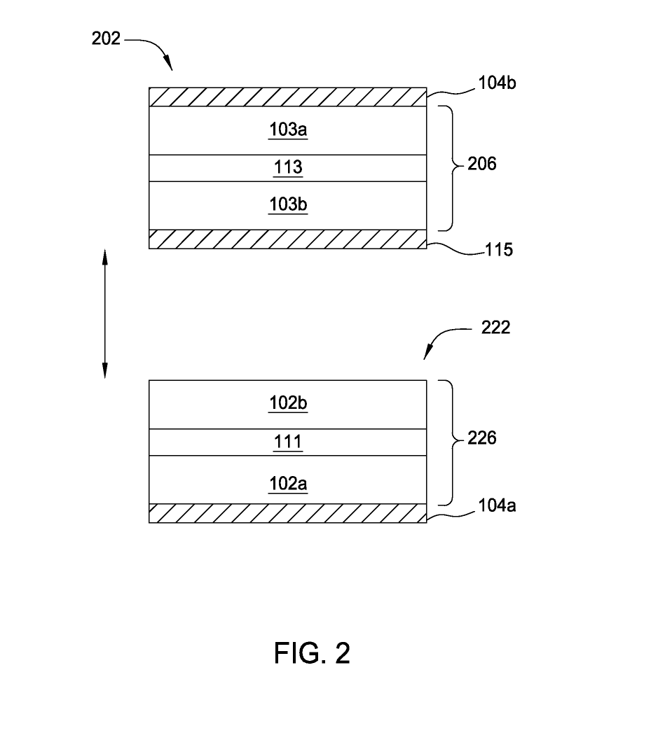

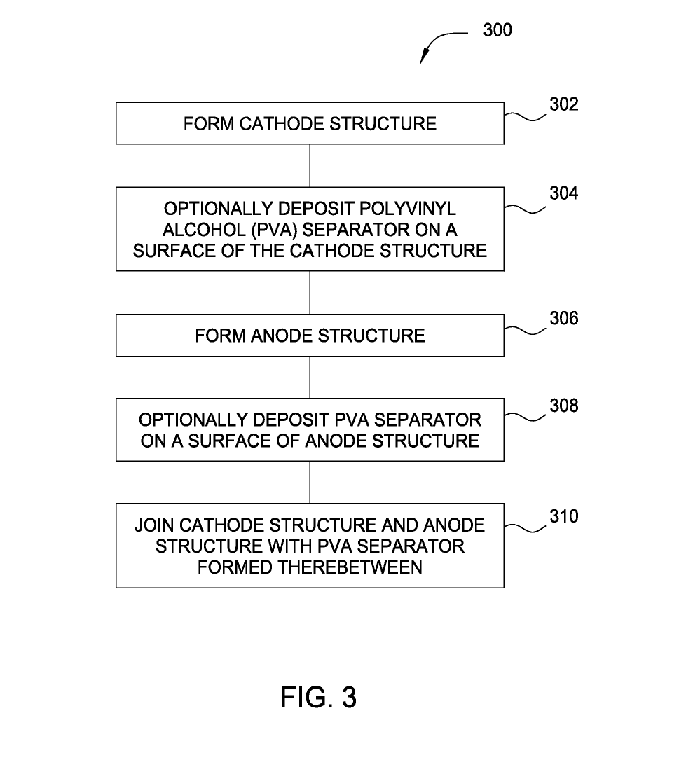

FIG. 2 is a schematic diagram of a cross-sectional view of one embodiment of a cathode stack 202 and an anode stack 222 with a PVA separator formed according to embodiments described herein. FIG. 3 is a process flow chart summarizing one embodiment of a method 300 for forming the cathode stack 202 and the anode stack 222 with a PVA separator 115 positioned therebetween of FIG. 2 according to embodiments described herein. In one embodiment, the cathode stack 202 comprises a bi-layer cathode structure 206, separator layer 104b, and a PVA separator 115.

At block 302, the bi-layer cathode structure 206 is formed. In one embodiment, the bi-layer cathode structure 206 comprises a first cathode structure 103a, a cathodic current collector 113, and a second cathode structure 103b as depicted in FIG. 2. In one embodiment, the cathode stack 202 comprises a single layer cathode structure as depicted in FIG. 1 B.

The cathode structures 103a, 103b may comprise any structure for retaining lithium ions. In certain embodiments, the cathode structures 103a, 103b have a graded particle size throughout the cathode electrode structure. In certain embodiments, the cathode structures 103a, 103b comprise a multi-layer structure where the layers comprise cathodically active materials having different sizes and/or properties.

In one embodiment, the cathode structures 103a, 103b comprise a structure comprising a cathodically active material. The cathode structures 103a, 103b may be porous. In one embodiment, the cathodically active material is selected from the group comprising: lithium cobalt dioxide (LiCoO₂), lithium manganese dioxide (LiMnO₂), titanium disulfide (TiS₂), LiNixCo₁₋₂ₓMnO₂, LiMn₂O₄, LiFePO₄, LiFe₁₋ₓMgPO₄, LiMoPO₄, LiCoPO₄, Li₃V₂(PO₄)₃, LiVOPO₄, LiM P₂O₇, LiFe_{1.5}P₂O₇, LiVPO₄F, LiAlPO₄F, Li₅V(PO₄)₂F₂, Li₅Cr(PO₄)₂F₂, Li₂CoPO₄F, Li₂NiPO₄F, Na₅V₂(PO₄)₂F₃, Li₂FeSiO₄, Li₂MnSiO₄, Li₂VOSiO₄, LiNiO₂, and combinations thereof. In one embodiment, the cathode structures further comprise a binding agent selected from the group comprising: polyvinylidene fluoride (PVDF), carboxymethyl cellulose (CMC), and water-soluble binding agents, such as styrene butadiene rubber (SBR), conductive binder, and other low or no-solvent binders.

In certain embodiments, the cathode structures 103a, 103b may be formed using embodiments described herein. In one embodiment, the cathode structures 103a, 103b may be applied using powder application techniques including but not limited to sifting techniques, hydraulic spray techniques, atomizing spray techniques, ectrospray techniques, plasma spray techniques, thermal or flame spray techniques, plasma spraying techniques, fluidized bed coating techniques, slit coating techniques, roll coating techniques, and combinations thereof, all of which are known to those skilled in the art. In certain embodiments, the cathode electrodes have a graded porosity such that the porosity varies throughout the structure of the cathode electrode. In certain embodiments, where a dual-sided bi-layer electrode is formed, such as the bi-layer cathode structure 206 depicted in FIG. 2, the cathode structure 103a and the cathode structure 103b may be simultaneously deposited on opposing sides of the cathodic current collector 113 using a dual-sided deposition process. For example, a dual-sided electrostatic spraying process which uses opposing spray applicators to deposit cathodically active material on opposing sides of the substrate. One exemplary embodiment of a dual-sided electrostatic spraying chamber is disclosed in commonly assigned U.S. patent application Ser. No. 12/880,564, titled SPRAY DEPOSITION MODULE FOR AN IN-LINE PROCESSING SYSTEM, filed Sep. 13, 2010 to Bachrach et al.

At block 304 a PVA separator 115 may be deposited on a surface of the cathode structure 206. The PVA separator comprises a PVA layer. The PVA separator 115 may be deposited using deposition techniques including electrospinning techniques and electrospraying techniques. The PVA separator 115 may be formed using the polymer solution or the separator forming solution as previously described herein.

In embodiments where the PVA separator is electrospun, the PVA separator may comprise PVA nano-fibers. The PVA nano-fibers may have a diameter between about 50 nanometer and 1,000 nanometers, for example, between 100 nanometers and 200 nanometers.

The PVA separator may have a thickness from about 1 micron to about 100 microns, for example, from about 1 micron to about 20 microns. The PVA separator may have porosity between about 40% to about 90% as compared to a solid film formed from the same material. The PVA separator may have porosity between about 60% to about 80% as compared to a solid film formed from the same material.

The PVA separator may further comprise a first layer of ceramic material formed on a first side of the PVA layer. The PVA separator may further comprise a second layer of ceramic material formed on a second side of the PVA layer. The ceramic material may comprise the ceramic materials or particles previously described herein. The ceramic material may be deposited using electrospray techniques.

At block 306, an anode stack 222 is formed. In one embodiment, the anode stack 222 comprises a bi-layer anode structure 226 and separator 104a. In one embodiment, the bi-layer anode structure 226 comprises a first anode structure 102a, an anodic current collector 111, and a second anode structure 102b as depicted in FIG. 2. In one embodiment, the anode stack 222 comprises a single layer anode structure as depicted in FIG. 1B.

In certain embodiments, the anode structures 102a, 102b may be formed according to embodiments described herein. In one embodiment, the anode structures 102a, 102b may be carbon based structure, either graphite or hard carbon, with particle sizes around 5-15 μm. In one embodiment, the lithium-intercalation carbon anode is dispersed in a matrix of polymeric binding agent. The anode structures 102a, 102b may be porous. Carbon black may be added to enhance power performance. The polymers for the binding agent matrix are made of thermoplastic or other polymers including polymers with rubber elasticity. The polymeric binding agent serves to bind together the active material powders to preclude crack formation and promote adhesion to the collector foil. The quantity of polymeric binding agent may be in the range of 1% to 40% by weight. The quantity of polymeric binding agent may be in the range of 10% to 30% by weight. The electrolyte containing material of the anode structures 102a, 102b may be made from materials described above, for example, graphitic particles dispersed in a polymer matrix and/or various fine powders, for example, micro-scale or nano-scale sized powders. Additionally, microbeads of silicon, tin, or lithium titanate (Li₄Ti₅O₁₂) may be used with, or instead of, graphitic microbeads to provide the conductive core anode material.

In one embodiment, the anode structures comprise conductive microstructures formed as a three dimensional, columnar growth of material by use of a high plating rate electroplating process performed at current densities above the limiting current (i_{L}). The diffusion-limited electrochemical plating process by which conductive microstructures in which the electroplating limiting current is met or exceeded, thereby producing a low-density metallic meso-porous/columnar structure rather than a conventional high-density conformal film. Different configurations of conductive microstructures are contemplated by embodiments described herein. The conductive microstructures may comprise materials selected from the group comprising copper, tin, silicon, cobalt, titanium, alloys thereof, and combinations thereof. Exemplary plating solutions and process conditions for formation of the conductive microstructures are described in commonly assigned U.S. patent application Ser. No. 12/696,422, filed Jan. 29, 2010, to Lopatin et al., titled POROUS THREE DIMENSIONAL COPPER, TIN, COPPER-TIN, COPPER-TIN-COBALT, AND COPPER-TIN-COBALT-TITANIUM ELECTRODES FOR BATTERIES AND ULTRA CAPACITORS, now published as US 2010/0193365, which is herein incorporated by reference in its entirety.

In one embodiment, the current collectors 111 and 113 may comprise a material individually selected from the group comprising aluminum (Al), copper (Cu), zinc (Zn), nickel (Ni), cobalt (Co), tin (Sn), silicon (Si), manganese (Mn), magnesium (Mg), alloys thereof, and combinations thereof. In one embodiment, the cathodic current collector 113 is aluminum and the anodic current collector 111 is copper. Examples of materials for the positive current collector 113 (the cathode) include aluminum, stainless steel, and nickel. Examples of materials for the negative current collector 111 (the anode) include copper (Cu), stainless steel, and nickel (Ni). Such collectors can be in the form of a foil, a film, or a thin plate. In certain embodiments, the collectors have a thickness that generally ranges from about 5 to about 50 μm.

At block 308 the PVA separator 115 may be deposited on a surface of the anode structure 226. The PVA separator 115 may be deposited on the cathode stack 202, the anode stack 222, or both prior to joining the anode stack 222 and the cathode stacks 202 together at block 308.

At block 310, the cathode stack 202 and the anode stack 222 are joined together with the PVA separator 115 formed therebetween. In one embodiment, the cathode stack 202 and the anode stack 222 may be packaged using a lamination process with a packaging film-foil, such as, for example, an Al/Al₂O₃ foil.

### EXAMPLES

The following hypothetical non-limiting examples are provided to further illustrate embodiments described herein. However, the examples are not intended to be all inclusive and are not intended to limit the scope of the embodiments described herein.

### Example 1

A 10% by weight polyvinyl alcohol (PVA) in water solution is used. The solution is loaded into a syringe with a 0.4 mm id flat capillary tip. A dc-dc convertor is used to supply from 5 to 30 kV to the tip of the capillary to form a Taylor cone with a liquid jet, and a grounded metal movable sample stage (e.g., aluminum foil) is used as the collector. The distance between the tip and the collector is varied from 50 mm to 200 mm. The samples are spun for a few minutes each, and the liquid flow rate is manually adjusted to maintain a small droplet of solution on the tip of the capillary. A Universal Serial Bus (USB) camera microscope is used to observe the liquid emission from the tip during the spinning process.

### Example 2

A 10% by weight polyvinyl alcohol (PVA), 0.5% by weight silica, in water solution is used. The solution is loaded into a syringe with a 0.4 mm id flat capillary tip. A dc-dc convertor is used to supply from 5 to 30 kV to the tip of the capillary to form a Taylor cone with a liquid jet, and a grounded metal movable sample stage (e.g., aluminum foil) is used as the collector. The distance between the tip and the collector is varied from 50 mm to 200 mm. The samples are spun for a few minutes each, and the liquid flow rate is manually adjusted to maintain a small droplet of solution on the tip of the capillary. A Universal Serial Bus (USB) camera microscope is used to observe the liquid emission from the tip during the spinning process.

### Example 3

A 10% by weight polyvinyl alcohol (PVA), 5% by weight silica, in water solution is used. The solution is loaded into a syringe with a 0.4 mm id flat capillary tip. A dc-dc convertor is used to supply from 5 to 30 kV to the tip of the capillary to form a Taylor cone with a liquid jet, and a grounded metal movable sample stage (e.g., aluminum foil) is used as the collector. The distance between the tip and the collector is varied from 50 mm to 200 mm. The samples are spun for a few minutes each, and the liquid flow rate is manually adjusted to maintain a small droplet of solution on the tip of the capillary. A Universal Serial Bus (USB) camera microscope is used to observe the liquid emission from the tip during the spinning process.

### Example 4

A 10% by weight polyvinyl alcohol (PVA), 5% by weight silica, in water solution is electrosprayed onto an aluminum foil substrate at 120 degrees Celsius. The distance between the electrospray gun and the collector is varied from 50 mm to 200 mm. The samples are sprayed for a few minutes each, and the liquid flow rate is manually adjusted to achieve a desired porosity. A Universal Serial Bus (USB) camera microscope is used to observe the liquid emission from the tip during the spinning process.

### Example 5

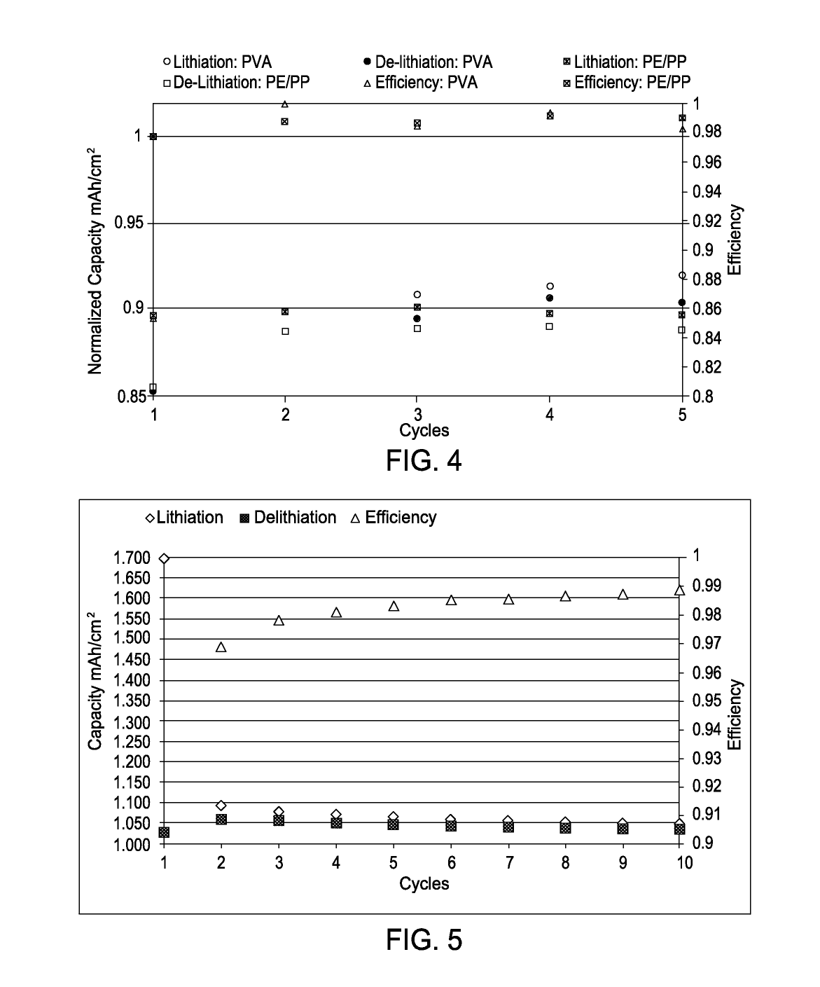

A 27 μm thick PVA fibrous mat was electrospun from 10 wt. % PVA (water) and used as a separator in a coin cell (using an in-house baseline 74 μm thick cathode). Initially, the PVA was electrospun directly onto the cathode but there was limited adhesion. Instead, a fibrous PVA mat was electrospun and then cut to a desired size for coin cell assembly. The coin cell demonstrated expected cycling performance after a simple 5-cycle charge-discharge electrical test at a rate of 0.2 C. As shown in FIG. 4, the electrospun PVA separator is very comparable to the standard commercially available polyethylene (PE)/polypropylene (PP) separators for this rate and number of cycles.

The same cell was tested at a higher rate to see if the electrospun PVA separator facilitates dendrite formation, in which case shorting would be observed. FIG. 5 shows the electrical data for 10 cycles at 1 C. As shown in FIG. 5, after 10 cycles, the cell was still cycling well and the cells' efficiency appears to be increasing.

The electrospun 27 μm thick PVA fibrous mat was characterized and compared to a commercially available 38 μm thick PP/PE/PP tri-layer separator. Capillary flow analysis indicated that the pores in the tri-layer separator were one order of magnitude larger than the pores in the electrospun PVA separator. The results are summarized in Table I.

TABLE I

| | | Commercially |
|---|---|---|
| | Electrospun PVA | Available Trilayer |
| Mean flow pore diameter (μm) | 0.2181 | 0.0312 |
| Bubble point pore diameter (μm) | 0.2968 | 0.0387 |
| Smallest detected pore (μm) | 0.1172 | 0.0258 |
| Largest detected pore (μm) | 0.2968 | 0.0387 |

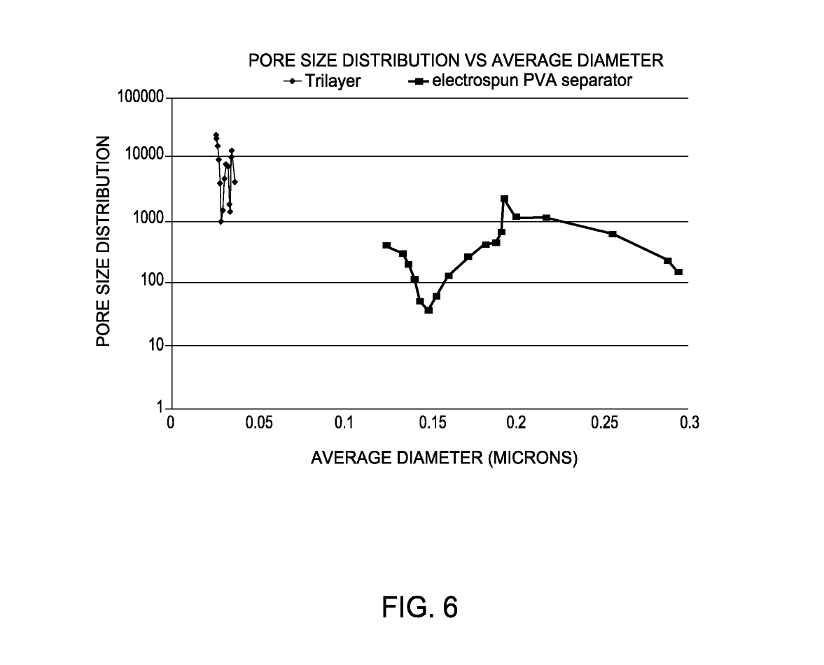

As shown in FIG. 6, capillary flow analysis indicated that the electrospun PVA separator has a broader distribution of pore sizes than the commercially available trilayer separator.

We also investigated the thermal shrinkage of the electrospun PVA. Two fibrous mats (on Al foil), PVA and Nylon-6, were placed in an over at 150° C. for 30 minutes. Afterwards, there was no apparent shrinkage. SEM imaging of these mats are heat treatment are in progress to see if any changes (at all) occurred to the fibers.

Hot Roller Process to Fabricate Li-Ion Films

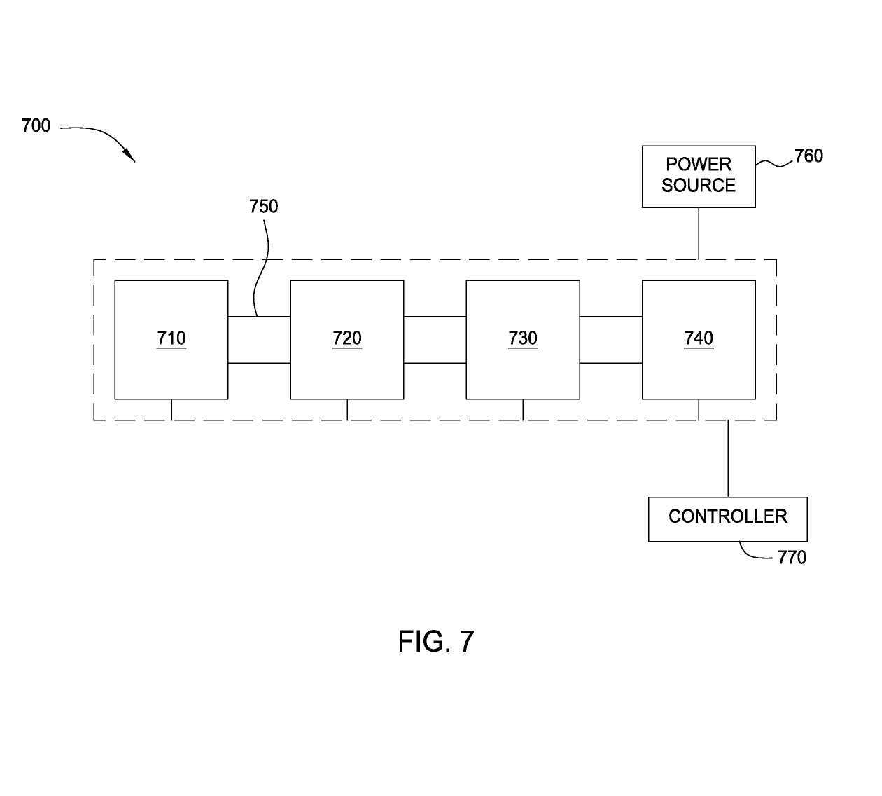

FIG. 7 is a schematic illustration of one embodiment of a vertical in-line spray processing system 700 having a spray module 720 with heated rollers according to embodiments described herein. The vertical in-line spray processing system 700 comprises an unwinding module 710 for supplying a flexible conductive substrate 750 to the spray module 720, the spray module 720 having heated rollers for depositing elctro-active materials over the flexible conductive substrate 750, a calendering module 730 for compressing the as-deposited electro-active materials to achieve a desired porosity, and a winding module 740 for collecting the processed flexible conductive substrate 750. The modules 710-740 are generally arranged along a line so that portions of the flexible conductive substrate 750 can be streamlined through each module through a common transport architecture. The common transport architecture may include a feed roll for supplying the flexible conductive substrate 750 and a take up roll for collecting the flexible conductive substrate 750. The feed roll may be positioned in the unwinding module 710 and the take-up roll may be positioned in the winding module 740. The feed rolls and take-up rolls may be activated simultaneously during substrate transferring in conjunction with optional intermediate transfer rollers to move each portion of the flexible conductive substrate 750 forward during processing.

The processing system 700 may be coupled to a power source 760 for supplying power to the various components of the processing system 700. The power source 760 may be an RF or DC source. The power source 760 may be coupled with a controller 770. The controller 770 may be coupled with the vertical processing system 700 to control operation of the modules 710-740. The controller 770 may include one or more microprocessors, microcomputers, microcontrollers, dedicated hardware or logic, and a combination of the same. Although four modules are shown, it should be understood that any number of modules may be included in the vertical in-line processing system 700.

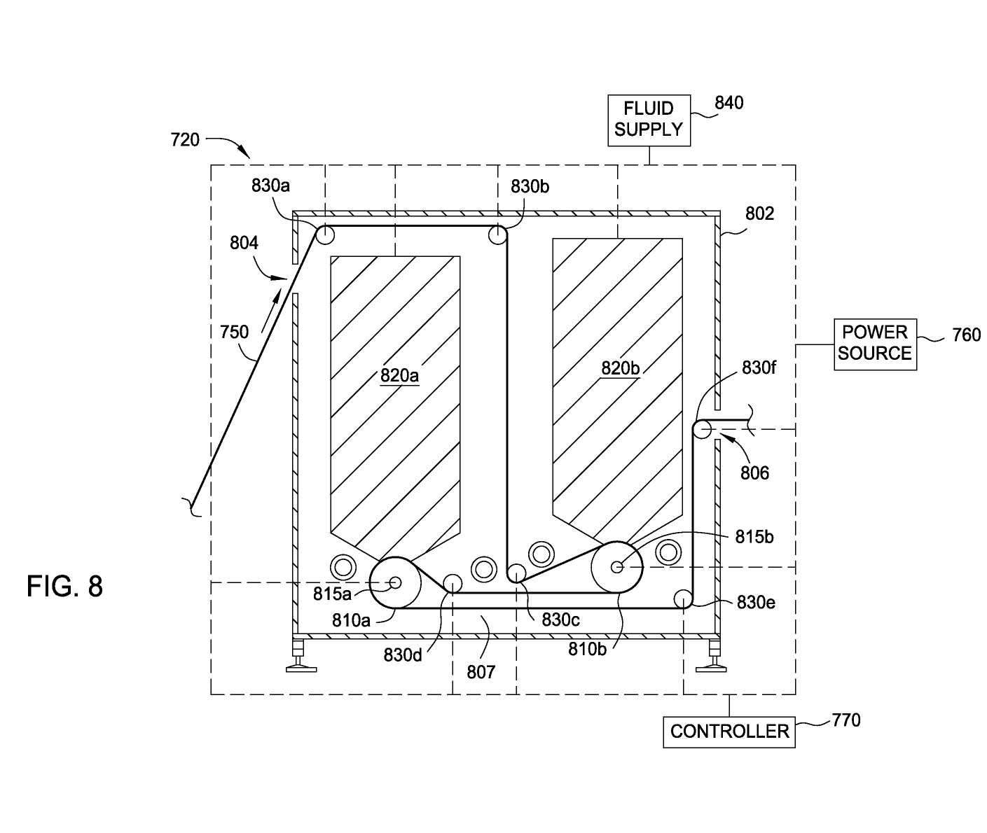

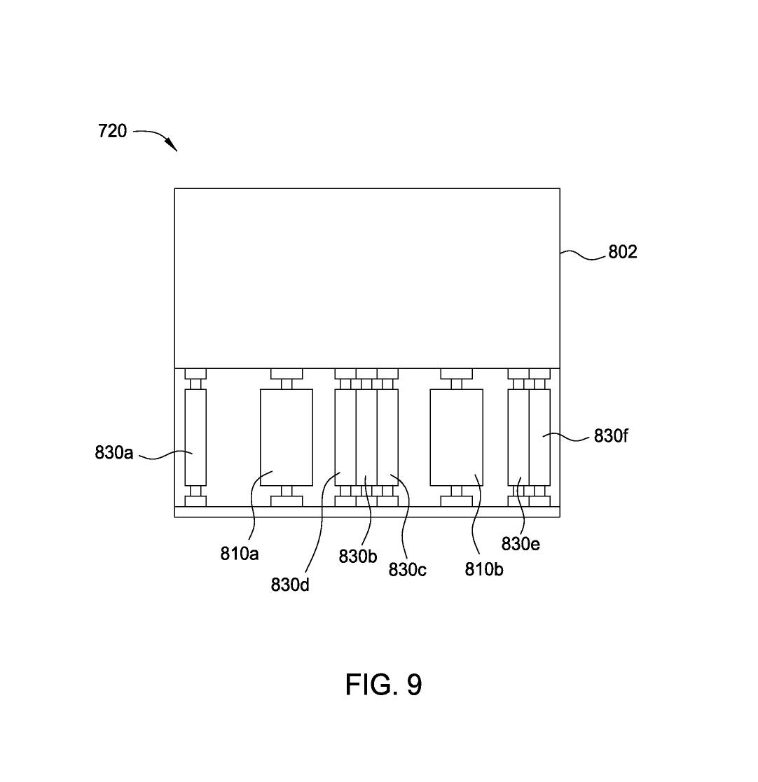

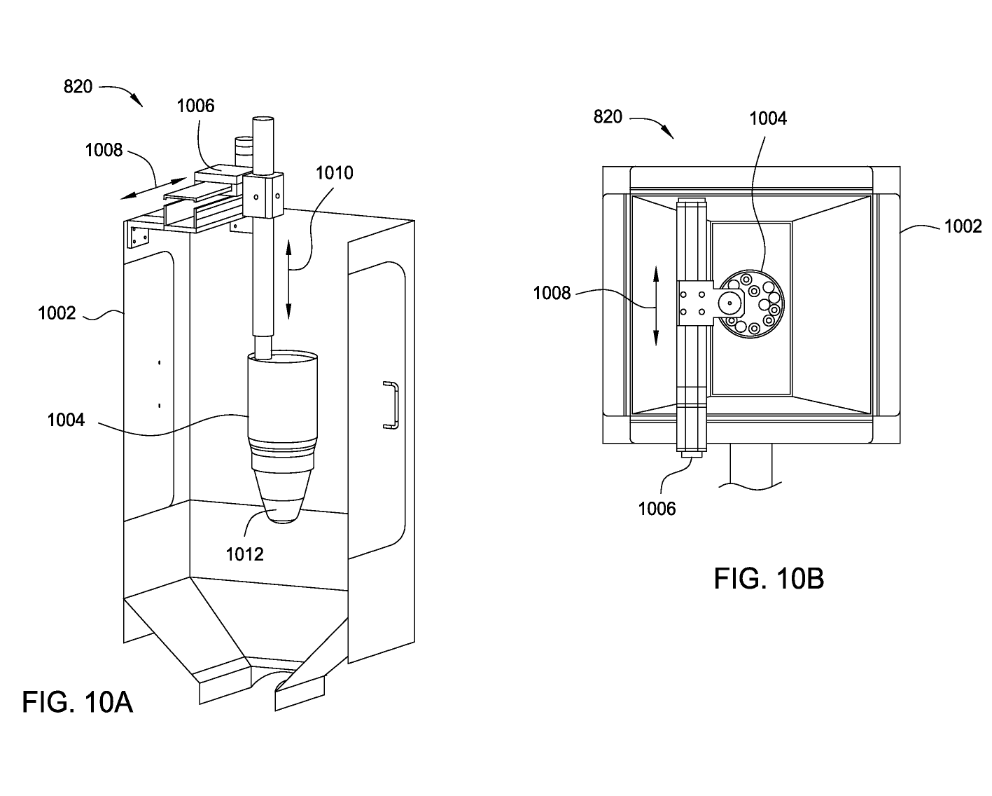

FIG. 8 is a schematic cross-sectional view of one embodiment of the spray module 720 having heated rollers 810a, 810b according to embodiments described herein. FIG. 10 is a schematic top view of one embodiment of the spray module 720 of FIG. 8 with the spray dispenser assemblies 820a, 820b removed. The spray module 720 is configured to deposit electro-active material over the conductive flexible substrate 750. As depicted in FIG. 8, the spray module 720 comprises a chamber body 802, a pair of heated rollers 810a, 810b, a pair of spray dispenser assemblies 820a, 820b for directing electro-active material toward the conductive flexible substrate, and a series of optional intermediate transfer rollers 830a -830e for supporting and transferring the flexible conductive substrate 750.

The chamber body 802 has a chamber inlet 804 for entry of the flexible conductive substrate 750 into a processing region 807 of the spray module 720 and a chamber outlet 806 for egress of the flexible conductive substrate 750 from the processing region 807.

The spray dispenser assemblies 820a, 820b may be positioned adjacent to the heated rollers 810a, 810b. As depicted in FIG. 8, the first spray dispenser assembly 820b and the second spray dispenser assembly 820a are positioned above the first heated roller 810b and the second heated roller 810a respectively. The spray dispenser assemblies 820a, 820b may be positioned to deposit electro-active material on opposing sides of the flexible conductive substrate 750. The spray dispenser assemblies 820a, 820b may be positioned to deposit electro-active material on the flexible conductive substrate 750 as the flexible conductive substrate 750 is transferred over the first heated roller 810b, and the second heated roller 810a respectively. Thus, the flexible conductive substrate 750 may be transferred over the first heated roller 810b while simultaneously spraying a first electro-active material over the flexible conductive substrate using the first spray dispenser assembly 820b and transferring the flexible conductive substrate 750 over a second heated roller 810a while simultaneously spraying a second electro-active material using the second spray dispenser assembly 820a over the flexible conductive substrate 750. Although two spray dispenser assemblies 820a, 820b and two heated rollers 810a, 810b are depicted, it should be understood that any number of spray dispensers and heated rollers may be used to achieve the desired deposition of electro-active material.

The electro-active material may be supplied as part of a dry powder mixture, a slurry mixture, or a gaseous mixture. The mixtures may comprise electro-active materials and at least one of a binder and a solvent.

Exemplary electro-active materials include cathodically active materials and anodically active materials. Exemplary cathodically active materials include lithium cobalt dioxide (LiCoO₂lithium manganese dioxide (LiMnO₂), titanium disulfide (TiS₂), LiNixCo₁₋₂ₓMnO₂, LiMn₂O₄, iron olivine (LiFePO₄) and it is variants (such as LiFe₁₋ₓMgPO₄), LiMoPO₄, LiCoPO₄, Li₃V₂(PO₄)₃, LiVOPO₄, LiMP₂O₇, LiFe_{1.5}P₂O₇, LiVPO₄F, LiAIPO₄F, Li₅V(PO₄)₂F₂, Li₅Cr(PO₄)₂F₂, Li₂CoPO₄F, Li₂NiPO₄F, Na₅V₂(PO₄)₂F₃, Li₂FeSiO₄, Li₂MnSiO₄, Li₂VOSiO₄, other qualified powders, composites thereof and combinations thereof. Exemplary anodically active materials include graphite, graphene hard carbon, carbon black, carbon coated silicon, tin particles, copper-tin particles, tin oxide, silicon carbide, silicon (amorphous or crystalline), silicon alloys, doped silicon, lithium titanate, any other appropriately electro-active powder, composites thereof and combinations thereof.

The mixtures may further comprise a solid binding agent or precursors for forming a solid binding agent. The binding agent facilitates binding of the electro-active material with the substrate and with other particles of the electro-active material. The binding agent is typically a polymer. The binding agent may be soluble in a solvent. The binding agent may be a water-soluble binding agent. The binding agent may be soluble in an organic solvent. Exemplary binding agents include styrene butadiene rubber (SBR), carboxymethylcellulose (CMC), polyvinylidene fluoride (PVDF) and combinations thereof. The solid binding agent may be blended with the electro-active material prior to deposition on the substrate 750. The solid binding agent may be deposited on the substrate 750 either prior to or after deposition of the electro-active material. The solid binding agent may comprise a binder, such as a polymer, to hold the powder on the surface of the substrate. It is preferred that the binding agent will generally have some electrical or ionic conductivity to avoid diminishing the performance of the deposited layer, however most binding agents are usually electrically insulating and some materials do not permit the passage of lithium ions. In one embodiment, the binding agent is a carbon containing polymer having a low molecular weight. The low molecular weight polymer may have a number average molecular weight of less than about 10,000 to promote adhesion of the nano-particles to the substrate.

The slurry or gas mixture may further comprise electro-conductive materials such as carbon black (CB) or acetylene black (AB).

Exemplary solvents include N-methyl pyrrolidone (NMP) and water.

Table I depicts various slurry compositions comprising a binder (SBR—styrene butadiene rubber), and electro-conductive material (CB—carbon black), and a cathodically active material (N MC).

TABLE I

| | SBR | CB | NMC |
|---|---|---|---|
| SBR Fixed | 3 | 6 | 91 |
| | 3 | 4 | 93 |
| | 3 | 3 | 94 |
| CB fixed | 5 | 4 | 91 |
| | 3 | 4 | 93 |
| | 2 | 4 | 94 |
| Corner | 4 | 8 | 88 |

In certain embodiments, the slurry mixture has a high content of solid material. The slurry mixture may have a high solid content of more than 30% by weight, more than 40% by weight, more than 50% by weight, more than 60% by weight, more than 70% by weight, more than 80% by weight, or more than 90% by weight based on the total weight percent of the slurry mixture. The slurry mixture may have a high content of solid material in the range of 30 to 95% by weight. The slurry mixture may have a high solid content of solid material in the range of 40 to 85% by weight. The slurry mixture may have a high solid content of solid material in the range of 50 to 70% by weight. The slurry mixture may have a high solid content of solid material in the range of 65 to 70% by weight.

The spray module may be coupled with a fluid supply 840 for supplying precursors, processing gases, processing materials such as cathodically active particles, anodically active particles, propellants, and cleaning fluids to the components of the spray module 720.

The heated rollers 810a, 810b may be heated by an internal heating mechanism 815a, 815b coupled with the power source 760. Exemplary internal heating mechanisms include heating coils, internal heating rods spaced at intervals, and heated fluid. The heated rollers 810a, 810b may be heated to any temperature that will dry the materials sprayed onto the flexible conductive substrate 750. For example, the heated rollers 810a, 810b may be heated to a temperature that dissolves solvents present in the electro-active material mixture sprayed from the spray dispenser assemblies 820a, 820b. The temperature of the heated rollers 810a, 810b may be selected such that the any liquids (e.g., solvents) present in the electro-active material mixture evaporate prior to contacting the heated flexible conductive substrate 750 or evaporate while in contact with the heated flexible conductive substrate. The heated rollers 810a, 810b may be heated to a temperature from about 50 degrees Celsius to about 250 degrees Celsius. The heated rollers 810a, 810b may be heated to a temperature from about 80 degrees Celsius to about 180 degrees Celsius.

The heated rollers 810a, 810b are dimensioned to provide a sufficient surface area for drying of the sprayed materials at elevated temperatures. The heated rollers 810a, 810b are of sufficient thermal mass such that the as deposited sprayed materials do not significantly cool the surface of the heated rollers 810a, 810b. The heated rollers 810a, 810b are dimensioned such that the flexible conductive substrate 750 may wrap around each heated roller 810a, 810b such that the flexible conductive substrate 750 covers at least 180 degrees of the circumference of the surface of each heated roller 810a, 810b. The flexible conductive substrate 750 may cover at least 180 degrees or more, 200 degrees or more, 220 degrees or more, 260 degrees or more, or 300 degrees or more of circumference of the surface of each heated roller 810a, 810b. The heated rollers 810a, 810b may have a diameter of at least 2 inches, 6 inches, or 12 inches and a diameter up to at least 6 inches, 12 inches, or 14 inches.

The heated rollers 810a, 810b may comprise any material that is compatible with process chemistries. The heated rollers 810a, 810b may comprise copper, aluminum, alloys thereof, or combinations thereof. The heated rollers 810a, 810b may be coated with another material. The heated rollers 810a, 810b may be coated with nylon or polymers. Exemplary polymers for coating the heated rollers include polyvinylidene fluoride (PVDF) and ethylene chlorotrifluoroethylene (ECTFE), commercially available under the trade name HALAR® ECTFE.

In certain embodiments, the heated rollers 810a, 810b, may be used to position and apply a desired tension to the flexible conductive substrate 750 so that the spray processes can be performed thereon. The heated rollers 810a, 810b may have a DC servo motor, stepper motor, mechanical spring and brake, or other device that can be used to position and hold the flexible conductive substrate 750 in a desired position within the spray module 720.

In operation, the flexible conductive substrate 750 enters the processing region 807 through the chamber inlet 804. The flexible conductive substrate 750 is guided by transfer rollers 830a, 830b, and 830c toward the first heated roller 810b. As the flexible conductive substrate 750 travels over the first heated roller 810b, a dry powder mixture, a slurry mixture or gas mixture comprising at least a first electro-active material and optionally a solvent is simultaneously sprayed from the spray dispenser assembly 820b toward the flexible conductive substrate 750. The temperature of the first heated roller 810b may be adjusted such that the solvent sprayed from the spray dispenser assembly 820b toward the flexible conductive substrate 750 evaporates as the slurry contacts the heated flexible conductive substrate 750. The evaporation temperature is dependent on the type of solvent used. The temperature of the first heated roller 810b may be adjusted such that the solvent sprayed from the spray dispenser assembly 820b toward the flexible conductive substrate 750 evaporates before the slurry contacts the heated flexible conductive substrate 750. The flexible conductive substrate 750 with a first layer of electro-active material deposited thereon is guided by transfer roller 830d to the second heated roller 810a. As the flexible conductive substrate 750 travels over the second heated roller 810a, a dry powder mixture, a slurry mixture, or gas mixture comprising at least a second electro-active material and an optional solvent is simultaneously sprayed from the second spray dispenser assembly 820a toward the flexible conductive substrate 750 where a second layer of electro-active material is formed over the first electro-active material. The temperature of the second heated roller 810a may be adjusted to evaporate the solvent as discussed above with regards to the first heated roller 810b. The flexible conductive substrate 750 is then guided out of the processing region 807 by transfer rollers 830e and 830f. The flexible conductive substrate 750 having the layers of electro-active material deposited thereon exits the processing region via the chamber outlet 806. The flexible conductive substrate 750 with the as-deposited layer may then be transferred to the calendering module 730 for further processing such as adjusting the porosity of the as-deposited layers.

The electro-active material of the first layer and the second layer may comprise the same electro-active material or different electro-active materials. The electro-active material of the first layer and the second layer may have the same average particle size or different average particle sizes. The electro-active material may be nickel-manganese-cobalt (NMC).

FIG. 10A is a perspective view of one embodiment of a spray dispenser assembly 820 (820a, 820b) according to embodiments described herein. FIG. 10B is a top view of one embodiment of the spray dispenser assembly 820 (820a, 820b) depicted in FIG. 10A. The spray dispenser assembly 820 comprises a body 1002 enclosing a spray dispenser 1004 having at least one spray nozzle 1012 for dispensing the electro-active material over a flexible conductive substrate which may affect the as-deposited porosity. The spray nozzle 1012 may be selected from hydraulic spray nozzles (i.e., utilizes the kinetic energy of the liquid to break it up into droplets), two fluid nozzles (i.e., nozzles that atomize by causing the interaction of high velocity gas and liquid), rotary atomizers, ultrasonic atomizers (i.e., spray nozzles utilizing high frequency (20 kHz to 50 kHz) vibration), and electrostatic nozzles. Exemplary hydraulic spray nozzles include plain orifice type nozzles, shaped orifice nozzles (i.e., flat fan spray nozzles having a hemispherical shaped inlet and a “V” notched outlet), surface impingement single fluid nozzles (i.e., a nozzle that causes a stream of liquid to impinge on a surface resulting in a sheet of liquid that breaks up into drops, pressure-swirl single fluid spray nozzle, solid cone single-fluid nozzle, and compound nozzles (i.e., multiple nozzles in a single nozzle body) Exemplary two fluid nozzles include internal-mix two-fluid nozzles and external-mix two-fluid nozzles.

The spray dispenser 1004 may be dimensioned such that the spray dispenser 1004 is movably secured to the body 1002. The spray dispenser 1004 may be an atomizer. The spray dispenser 1004 may be configured for hydraulic spray techniques, atomizing spray techniques, electrospray techniques, plasma spray techniques, and thermal or flame spray techniques. The spray dispenser 1004 may be movable in at least one of the x-direction and the y-direction to allow for varying coverage of the surface of the flexible conductive substrate 750. The spray dispenser 1004 may be adjusted to increase or decrease the distance between a nozzle of the spray dispenser 1004 relative to the flexible conductive substrate. The ability to adjust the spray dispenser 1004 relative to the flexible conductive substrate provides control over the size of the spray pattern. For example, as the distance between the flexible conductive substrate and the spray dispenser 1004 increases the spray pattern opens up to cover a larger surface area of the flexible conductive substrate 750, however, as the distance increases, the velocity of the spray decreases.

The spray dispenser 1004 may be coupled with a track 1006 for positioning the spray dispenser 1004 relative to a flexible conductive substrate. The spray dispenser 1004 is movable along the track 1006 in a horizontal direction as shown by arrow 1008. The spray dispenser 1004 is also movable in a vertical direction 1010. The movement of the spray dispenser 1004 may be manual or automated. The movement of the spray dispenser 1004 may be controlled by the controller 770.

The spray dispenser 1004 may be coupled with the power source 760 for exposing the deposition precursor to an electric field to energize the deposition precursor. The power source 760 may be an RF or DC source. Electrical insulators may be disposed in the sidewalls of the body 1002 and/or in the spray dispenser 1004 to confine the electric field to the spray dispenser 1004 or spray dispenser assembly 820.

The spray dispenser 1004 may be coupled with the fluid supply 840 for supplying precursors, processing gases, processing materials such as cathodically active particles, anodically active particles, propellants, and cleaning fluids.

The spray dispenser assembly 820 may comprise multiple dispensing nozzles positioned across the path of the flexible conductive substrate to cover the substrate uniformly. In certain embodiments, each spray dispenser 1004 has multiple nozzles and may be configured with all nozzles in a linear configuration, or in any other convenient configuration. To achieve full coverage of the flexible conductive substrate, each dispenser may be translated across the flexible conductive substrate while spraying activated precursor.

The spray dispenser 1004 may be coupled with or include a mixing chamber (not shown), which may feature an atomizer for liquid, slurry or suspension precursor, where the deposition precursor is mixed with the gas mixture prior to delivery into the spray deposition region.

The gas mixture that exits the spray dispenser assembly 820 may comprise the electro-active particles to be deposited on the substrate carried in a carrier gas mixture and may optionally comprise combustion products. The gas mixture may contain at least one of water vapor, carbon monoxide and dioxide, and trace quantities of vaporized electrochemical materials, such as metals. In one embodiment, the gas mixture comprises a non-reactive carrier gas component, such as argon (Ar) or nitrogen (N₂) that is used to help deliver the activated material to the substrate.

The gas mixture comprising the electro-active particles may further comprise a combustible mixture for triggering a combustion reaction which releases thermal energy and causes the activated material to propagate toward the flexible conductive substrate in spray patterns. The spray patterns may be shaped by at least one of the nozzle geometry, speed of gas flow, and speed of the combustion reaction to uniformly cover substantial portions of the flexible conductive substrate.

Pressure and gas flows may be adjusted within the spray dispenser assembly 1002 such that when the gas mixture comprising the activated particles and the carrier gas mixture contacts the flexible conductive substrate, the activated particles remain on the flexible conductive substrate 750 while the gas is reflected off of the flexible conductive substrate 750.

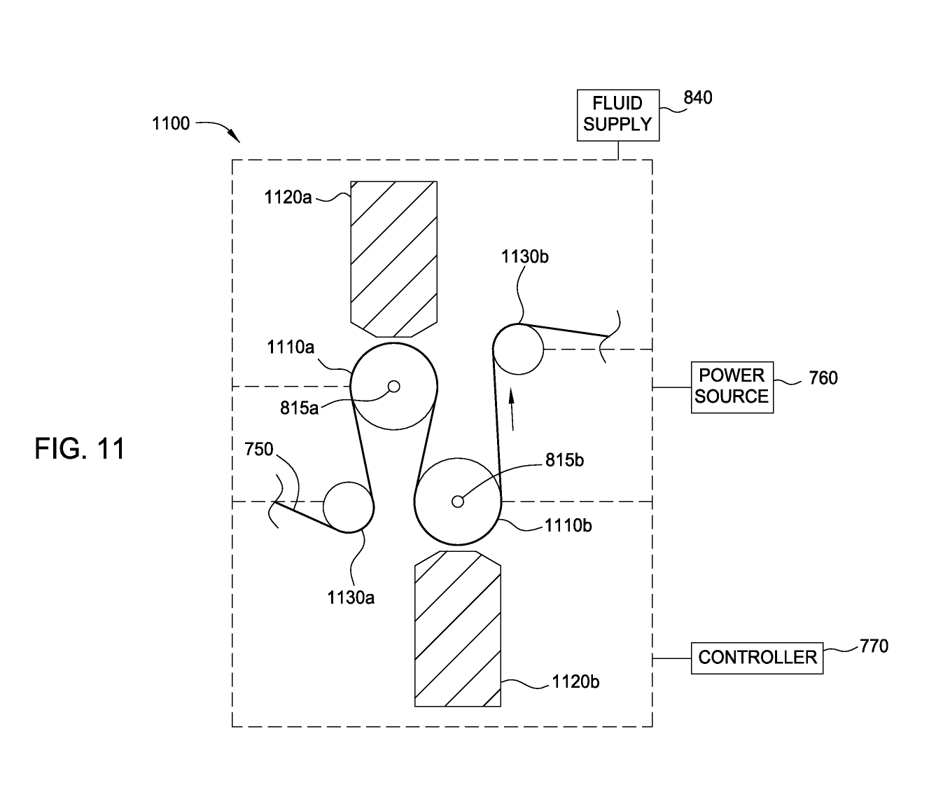

FIG. 11 is a schematic view of another embodiment of a spray module assembly 1100 having heated rollers 1110a, 1110b according to embodiments described herein. In embodiments where the flexible conductive substrate 750 is positioned vertically, FIG. 11 depicts a schematic overhead view. In embodiments, where the flexible conductive substrate 750 is positioned horizontally, FIG. 11 depicts a schematic side view. The spray module assembly 1100 is configured to deposit electro-active material over a first side of the conductive flexible substrate 750. Similarly to the spray module 720, the spray module assembly 1100 comprises a chamber body (not shown), a pair of heated rollers 1110a, 1110b, a pair of spray dispenser assemblies 1120a, 1120b for directing electro-active material toward a second side of the conductive flexible substrate 750, and a series of intermediate transfer rollers 1130a, 1130b for supporting and transferring the flexible conductive substrate 750.

While the foregoing is directed to embodiments of the invention, other and further embodiments of the invention may be devised without departing from the basic scope thereof.

What is claimed is:

1. A method for depositing an electro-active material over a flexible conductive substrate, comprising:
transferring a flexible conductive substrate over a first heated roller while simultaneously spraying a first electro-active material over the flexible conductive substrate; and
transferring the flexible conductive substrate over a second heated roller while simultaneously spraying a second electro-active material over the flexible conductive substrate, wherein the first and second electro-active materials each comprise a cathodically active material or an andodically active material.

2. The method of claim 1, wherein simultaneously spraying a first electro-active material and simultaneously spraying a second electro-active are performed using a spray technique selected from hydraulic spray techniques, atomizing spray techniques, electrospray techniques, plasma spray techniques, and flame spray techniques.

3. The method of claim 2, wherein the heated rollers are heated to a temperature between 50 degrees Celsius and 250 degrees Celsius.

4. The method of claim 3, wherein the flexible conductive substrate wraps around each heated roller and covers at least 180 degrees of the circumference of a surface of each heated roller.

5. The method of claim 2, wherein the first electro-active material and the second electro-active material are part of a slurry mixture further comprising a binding agent and a solvent.

6. The method of claim 5, wherein the slurry mixture has a high solid content of from about 50 wt. % to about 70 wt. %.

7. The method of claim 1, wherein the first electro-active material and the second electro-active material are deposited on opposing sides of the flexible conductive substrate.

8. A spray module for depositing an electro-active material over a flexible conductive substrate, comprising:
a first heated roller for heating and transferring the flexible conductive substrate;
a second heated roller for heating and transferring the flexible conductive substrate;
a first spray dispenser positioned adjacent to the first heated roller for spraying electro-active material onto the flexible conductive substrate as the flexible conductive substrate is heated by the first heated roller; and
a second spray dispenser positioned adjacent to the second heated roller for spraying electro-active material over the flexible conductive substrate as the flexible conductive substrate is heated by the second heated roller.

9. The spray module of claim 8, wherien the first spray dispenser and the second spray dispenser are positioned to deposit the electro-active material on opposing sides of the flexible conductive substrate.

10. The spray module of claim 8, wherien the first spray dispenser and the second spray dispenser are positioned to deposit the electro-active material on the same side of the flexible conductive substrate.

11. The spray module of claim 8, wherein the first spray dispenser and the second spray dispenser include at least one spray nozzle selected from the group comprising hydraulic spray nozzles, two fluid nozzles, rotary atomizers, ultrasonic atomizers, and electrostatic spray nozzles.

12. The spray module of claim 8, wherein the first heated roller and the second heated roller are dimensioned such that the flexible conductive substrate wraps around each heated roller and covers at least 180 degrees of a surface of each heated roller.

13. The spray module of claim 12, wherein the heated rollers comprise copper, aluminum, alloys thereof, or combinations thereof coated with nylon, polyvinylidene fluoride (PVDF), ethylene chlorotrifluoroethylene (ECTFE), or combinations thereof.

14. A separator for separating an anode electrode and a cathode electrode, comprising:
a polyvinyl alcohol (PVA) layer; and
inorganic particles embedded in the PVA layer.

15. The separator of claim 14, wherein the PVA layer is a nano-fiber backbone structure and the inorganic particles are embedded in the nano-fibers of the nano-fiber backbone structure.

16. The separator of claim 15, wherein the inorganic particles are ceramic particles.

17. The separator of claims 15, further comprising:
a first layer of ceramic particles formed on a first side of the PVA layer; and
a second layer of ceramic particles formed on a second side of the PVA layer.

18. The separator of claim 15, wherein the ceramic particles are selected from the group of: BaTiO₃, HfO₂ (hafnia), SrTiO₃, TiO₂ (titania), SiO₂ (silica), Al₂O_{3 (alumina), ZrO}₂ (zirconia), SnO₂, CeO₂, MgO, CaO, Y₂O₃, CaCO₃ and combinations thereof.

19. The separator of claim 15, wherein the nano-fibers of the nano-fiber backbone structure have a diameter between about 100 nanometers and about 200 nanometers.

20. The separator of claim 19, wherein the nano-fiber backbone structure has a porosity between about 40% to about 90% as compared to a solid film formed from the same material.
